(19) United States
(12) Patent Application Publication
(10) Pub. No.: US 2011/0072018 A1
(43) Pub. Date: Mar. 24, 2011

(54) HIERARCHICAL ADMINISTRATION OF RESOURCES

(76) Inventors: Jeffrey Joel Walls, Ft. Collins, CO (US); Byron A. Alcorn, Ft. Collins, CO (US)

(21) Appl. No.: 12/992,362

(22) PCT Filed: May 27, 2008
(86) PCT No.: PCT/US2008/064887

§ 371 Date: Nov. 12, 2010

(51) Int. Cl. G06F 17/30

(52) U.S. Cl. 707/737; 707/E17.089

(57) ABSTRACT

A method and system for administering assets in a hierarchical manner is provided. A plurality of assets (e.g., computing resources, servers) are provided. A system administrator can create asset groups and administrative groups. One or more assets can be assigned to an asset group. One or more asset groups can be assigned to an administrative group. Accordingly, a user that is assigned to an administrative group has the capability to manage the assets assigned to the user's administrative group.

### BACKGROUND OF THE INVENTION

The following description is provided simply as an aid in understanding the disclosure and is not admitted to describe or constitute prior art to the disclosure.

Following a current trend, information technology managers have begun to isolate IT assets (e.g., computing resources, intellectual property, policies) in a secure manner. Under this practice, IT assets such as servers, may be isolated, for example, in secure rooms. These secure rooms may house various IT assets that can be dedicated to specific users or groups.

Many administration issues can arise when IT assets (dedicated to different business entities) are co-located. Some IT assets may need to be available only to a specific set of users, security group or a specific set of access devices. In addition, the management of the IT assets may need to be restricted to an individual or a set of individuals. Further, policies governing the usage and behavior of the IT assets may vary based on the user or device that accesses a specific IT asset. Thus, there is a need for a method and system for administering IT assets.

### SUMMARY OF THE INVENTION

According to one embodiment, a method for administering assets includes assigning an asset to at least one asset group and assigning an administrative group to the asset group, wherein the administrative group is configured to control the asset in the asset group.

According to another embodiment, a method for administering assets, includes providing at least one asset, creating at least one asset group, creating at least one administrative group, assigning the asset group to the administrative group and assigning an asset to the asset group; wherein the administrative group is configured to manage the asset.

According to yet another embodiment, a computer-readable medium, having computer-executable instructions for performing a method includes assigning an asset to at least one asset group and assigning an administrative group to the asset group, wherein the administrative group is configured to control the asset in the asset group.

According to still another embodiment, a system for administering a set of assets includes a database component operative to maintain a database identifying assets, asset groups and administrative groups and a server for assigning an asset to at least one asset group and assigning an administrative group to the asset group, wherein the administrative group is configured to control the asset in the asset group.

According to another embodiment, a facility includes at least one asset, a computer system including a computer program executing on the system, wherein the program assigns an asset to at least one asset group and assigns an administrative group to the asset group, wherein the administrative group is configured to control the asset in the asset group.

According to still another embodiment, a system for administering a set of assets, includes means for assigning an asset to at least one asset group and means for assigning an administrative group to the asset group, wherein the administrative group is configured to control the asset in the asset group.

It is to be understood that both the foregoing general description and the following detailed description are exemplary and explanatory only, and are not restrictive of the disclosure.

### BRIEF DESCRIPTION OF THE DRAWINGS

Features, aspects and advantages of the present disclosure will become apparent from the following description, appended claims, and the accompanying exemplary embodiments shown in the drawings, which are briefly described below.

FIG. 1 is a block diagram of an administration system for managing assets, according to one embodiment.

FIG. 2 is a block diagram illustrating the scope of a system administrator, according to one embodiment.

FIG. 3 is a block diagram illustrating the scope of administrative groups according to one embodiment.

FIG. 4 is a block diagram of components in an administration system server, according to one embodiment.

FIG. 5 is a user interface for an asset group management component, according to one embodiment.

FIG. 6 is a user interface for an administrative group management component, according to one embodiment.

FIG. 7 is a user interface for an asset assignment component, according to one embodiment.

FIG. 8 is a user interface for an asset group assignment component, according to one embodiment.

FIG. 9 is a user interface for a log component, according to one embodiment.

FIG. 10 is a user interface for a report component, according to one embodiment.

FIGS. 11(a)-(b) are flowcharts for administering a set of assets according to one embodiment.

### DETAILED DESCRIPTION

Embodiments of the present disclosure will be described below with reference to the accompanying drawings. It should be understood that the following description is intended to describe exemplary embodiments of the disclosure, and not to limit the disclosure.

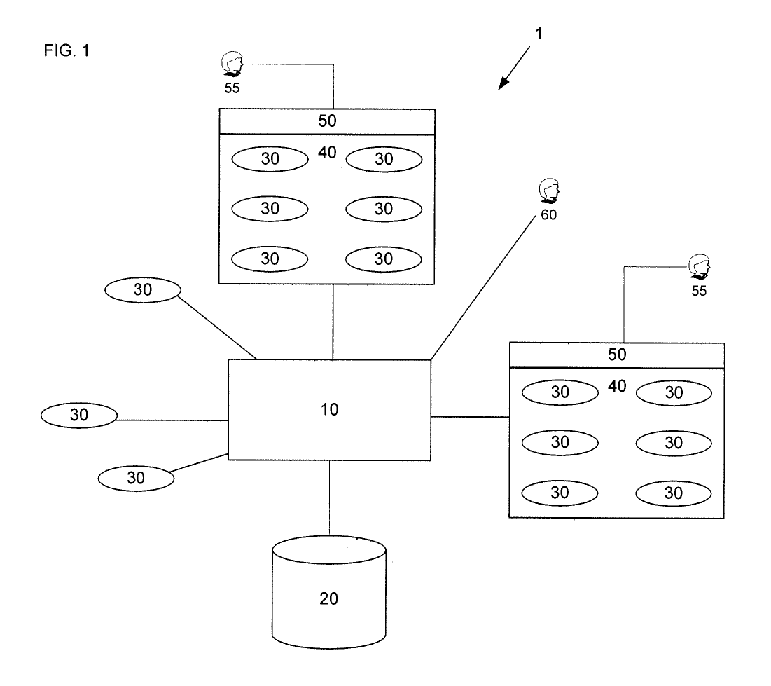

FIG. 1 discloses an administration system 1 for administering a set of assets 30. A server 10 can be configured to execute software to manage a plurality of different assets 30. For example, the server 10 can assign assets 30 to one or more asset groups 40. In addition, the server 10 can create one or more administrative groups 50 that are assigned to manage assets 30 that may be associated with at least one of the asset groups 40. A database component 20 maintains a database for identifying, at least, assets 30, asset groups 40, administrative groups 50 and related information. According to one embodiment, a system administrator 60 can interact with the server 10 to perform the various functions mentioned above.

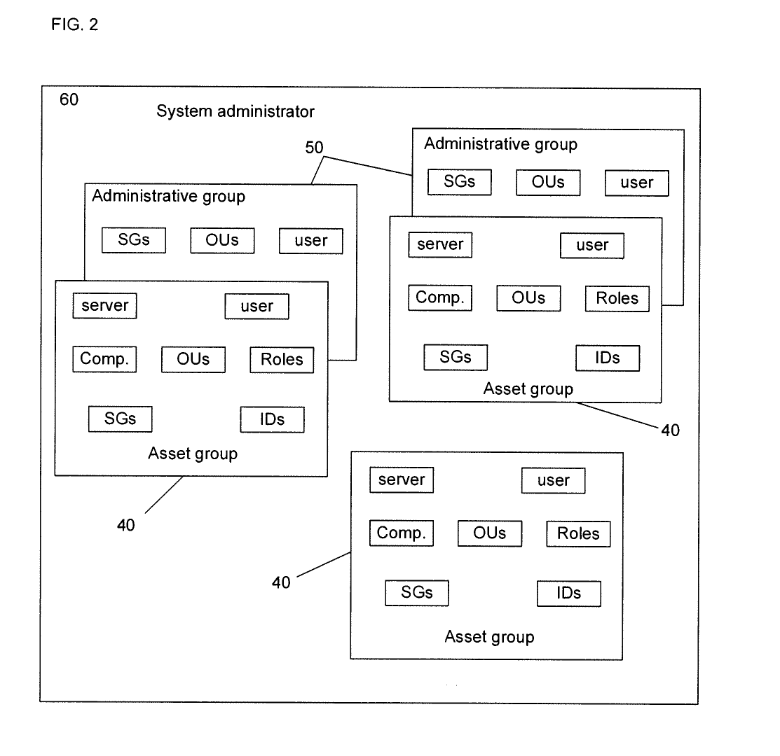

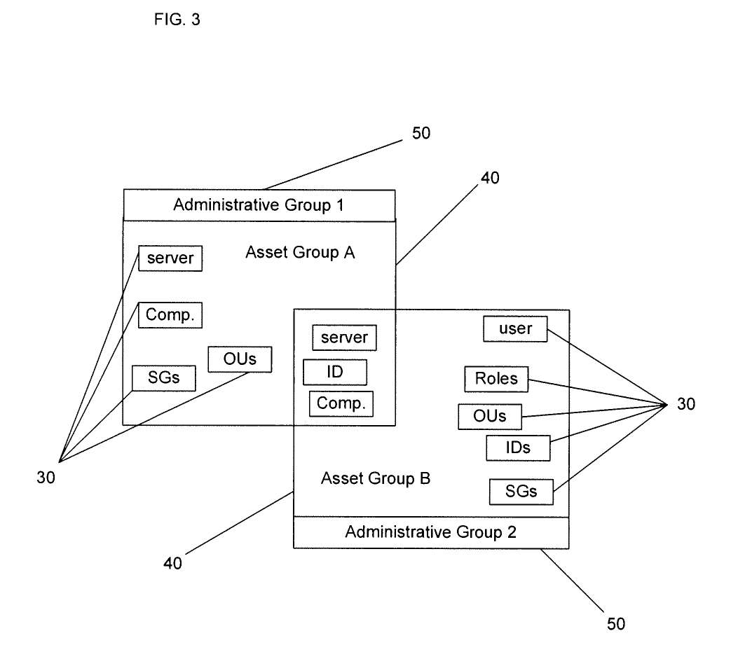

As indicated in FIGS. 2 and 3, assets 30 can be any one of organization units (OU), security groups (SG), individual users, servers, clients (i.e., computing resources), monitor layout identifications, roles, policies, logs, reports and access permissions. Organizational units, security groups and users may define people or groups of people who seek to access and use other assets such as client computers and servers. Servers are assets that are designed to run and serve applications to clients and other computing resources. According to one embodiment, the servers can be Blade servers. Clients can be computing resources such as client computers, dumb terminals, etc. Monitor layout identifications can associate specific monitor arrangements with computing resources, individual users, organizational units, etc. Roles can be a set of responsibilities, activities and authorizations that are granted to organization units, security groups, individual users, etc. Policies can be rules that govern acceptable use of resources (e.g., computers, servers, workstations, etc.) security practices and operational procedures. Logs and reports can convey information about how the administration system 1 or assets 30 are running.

According to one embodiment, asset groups 40 may consist of one or more assets 30. Asset groups 40 allows a single server 10 to manage the capabilities of multiple business entities. According to another embodiment, as shown in FIG. 3, a single asset 30 can belong to one or more asset groups 40. An organizational group identifier is used to assign/group (tag) assets 30 into asset groups 40. The organizational group identifier for each asset 30 is communicated to the server 10. The server 10 can modify the organizational group identifier and thus the grouping of assets 30. Alternatively, the organizational group identifier can be preconfigured in an asset 30. For example, the organizational group identifier can be preconfigured in a server configuration file or a client computer configuration file. Users and roles can be tagged with an asset group 40 when added or can be changed from one asset group 40 to another using the organizational group identifier. In addition, asset groups 40 are tagged to identify those administrative groups 50 that are allowed to have administrative rights to the asset group 40. Administrative rights which will be discussed further below include: view, create, modify, and delete.

The system 1 allows the creation of multiple administrative groups 50. Administrative groups 50 allow organizational units, security groups and individual users to manage assets 30 and asset groups 40. According to one embodiment, an administrative group 50 can only view and manage those assets 30 that are assigned to the administrative group 50. That is the administrative group 50 can view, create, modify, or delete assets 30 in the asset group 40 to which the administrative group 50 is assigned. According to an alternative embodiment, administrative groups 50 can view all assets 30 in any asset group 40 even if the administrative group 50 is not assigned to that asset group 40. Preferably, the administrative system 1 restricts administrative groups 50 so that an administrative group 50 can only view asset groups 40 controlled by the specific administrative group 50.

According to another embodiment, an organizational administrator 55 is designated to view, create, modify or delete assets 30 within a specified administrative group 50. Organizational administrators 55 are tagged with administrative group 50 names. The organizational administrator 55 can add assets (e.g., organizational units, security groups and users) to a specific asset group 40. When an asset 30 is added, it is tagged to indicate the specific administrative group 50 and/or asset group 40 to which the asset 30 belongs. According to one embodiment, the organizational administrator 55 can move assets 30 to various asset groups 40 not controlled by that organizational administrator 55.

According to one embodiment, a selected administrative group 50 can be assigned to manage at least one of the asset groups 40 comprising one or more assets 30 (servers, clients, monitor layout identifications). According to one embodiment, assets 30 in the administrative system 1 that are not designated for an asset group 40 can be modified and viewed by any administrative group 50. According to another embodiment, the first administrative group 50 that designates an undesignated asset 30 for an asset group 40 is granted the ability to view and modify the asset 30.

According to another embodiment, a selected administrative group 50 can be assigned to manage at least one of the asset groups 40 comprising one or more roles. Roles in the system that are not designated for an asset group 40 can be modified and viewed by any administrative group 50.

According to one embodiment, a selected administrative group 50 can be assigned to manage at least one of the asset groups 40 comprising one or more policies. Policies in the system that are not designated for an asset group 40 can be modified and viewed by any administrative group 50.

According to another embodiment, a selected administrative group 50 can be assigned to manage at least one of the asset groups 40 comprising one or more organizational units, security groups and users. Organizational units, security groups and users in the system that are not designated for an asset group 40 can be modified and viewed by any administrative group 50. According to one embodiment, system administrators 60 are a type of user that can view and modify assets that belong to a particular administrative group 50.

FIG. 2 pictorially represents the scope of access a multi-level system administrator 60 can possess. When the system administrator 60 logs into the administration system 1, the system will determine what administrative groups 50 the system administrator 60 belongs to and what asset groups 40 are assigned to those administrative groups 50.

As shown in FIG. 2, the system administrator 60 can assign/group assets 30 and create one or more asset groups 40. In addition, the system administrator 60 can create administrative groups 50. The system administrator 60 also has the ability to set attributes for the administrative groups 50. Further, the system administrator 60 may define which administrative group 50 controls which asset group 40.

According to another embodiment, the system administrator 60 is responsible for assigning assets (users, resources) to asset groups 40. The assignment can be made by modifying a configuration file of certain assets 30. The system administrator 60 can configure other administrator groups 50 to modify, add, create or delete users and other resources.

According to one embodiment, the system administrator 60 may grant an administrative group 50 the ability to view, create, modify, delete assets 30 in the administrative group 50. For example, a system administrator 60 can change an asset's 30 asset group 40 to a new asset group 40 with a new administrative group 50. In turn, the system administrator 60 modifies the asset's 30 old administrative group 50 so that it loses ability to modify the asset 30.

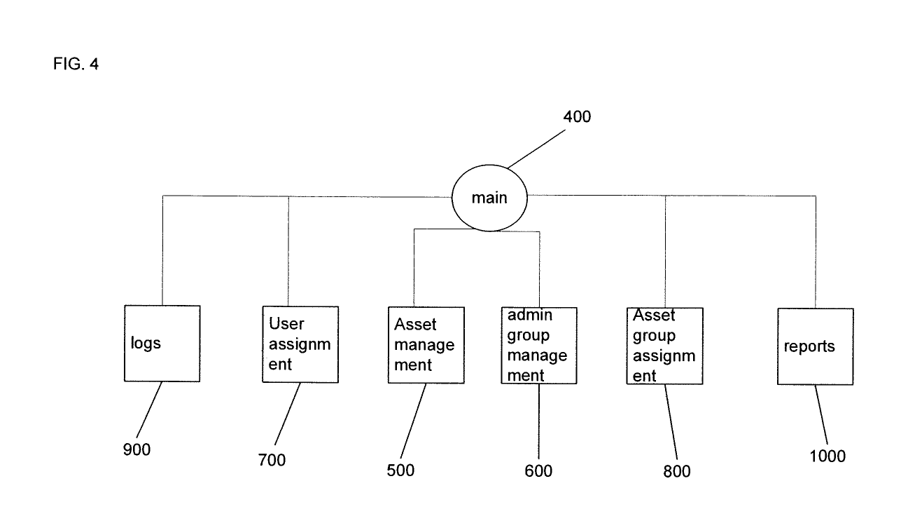

FIG. 4 is a block diagram of components that can be used in the administration system 1, according to one embodiment. The components may be implemented with software comprising at least a user interface and business logic for interacting with the database 20. According to one embodiment all components can be accessed from a main interface component 400. Alternatively, each component is accessible regardless of the present component that a user is using.

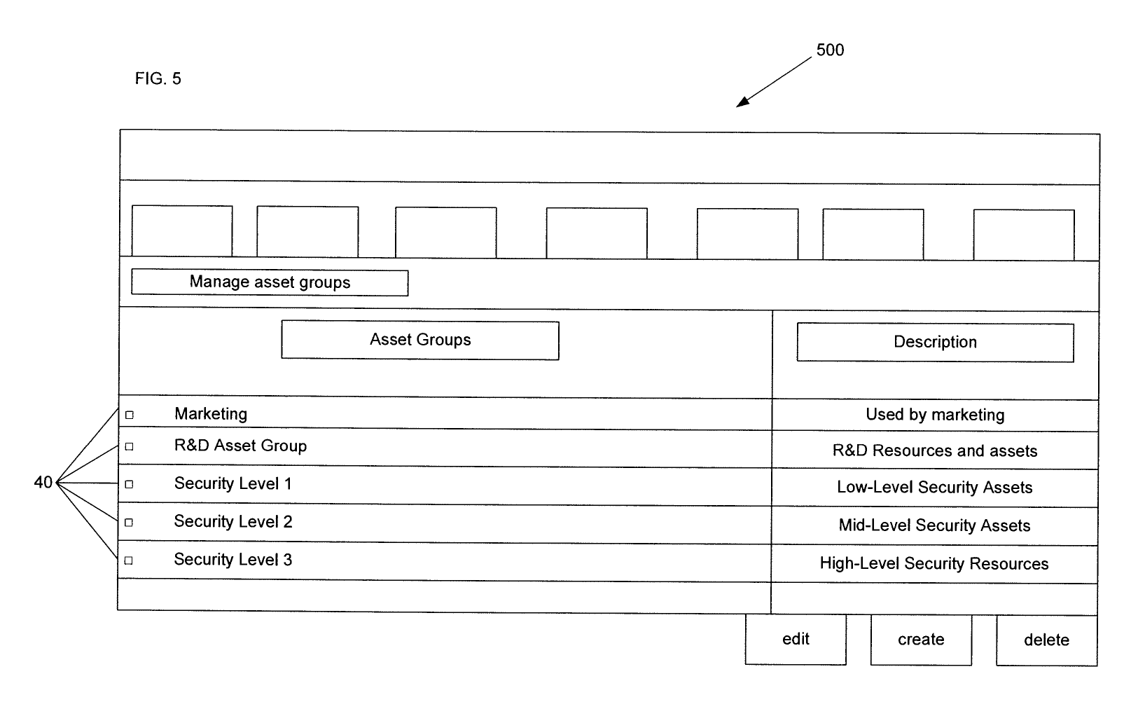

The asset management component 500 is configured to create and manage (edit and delete) asset groups 40. FIG. 5 shows a user interface for an asset management component 500 according to one embodiment. FIG. 5 shows that five asset groups 40 have been created. The first two asset groups 40 are a grouping of assets 30 based on organization type (e.g., marketing, R&D Asset Group). The last three asset groups 40 are a grouping of assets 30 based on security levels.

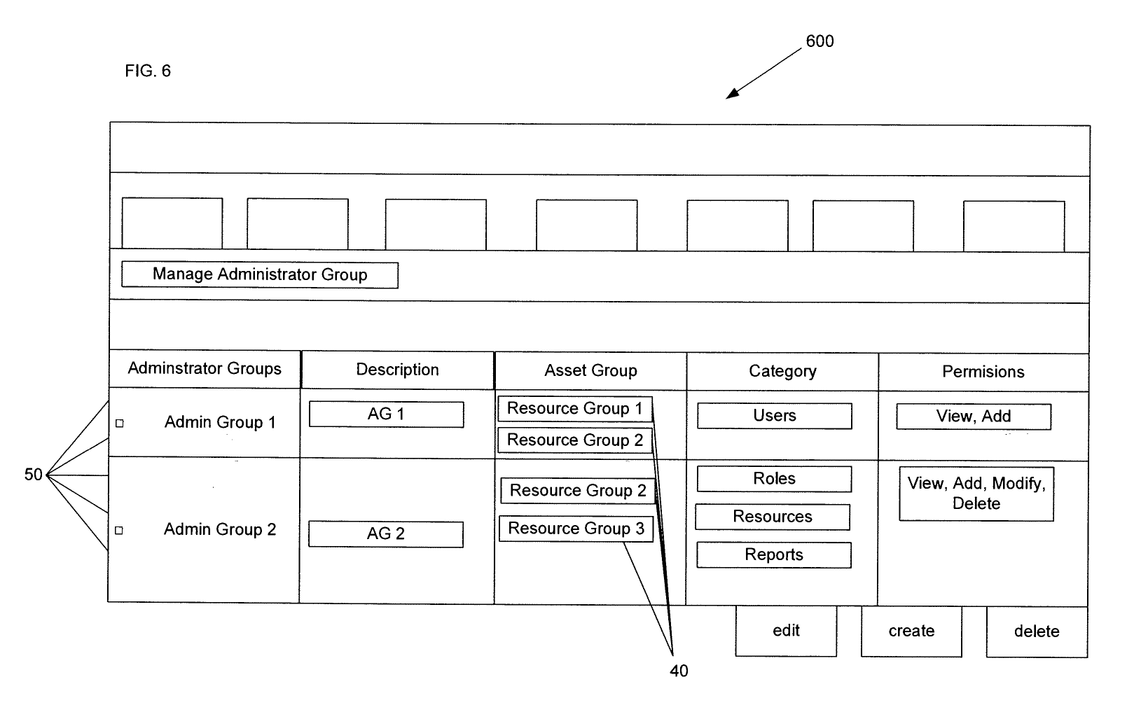

The administrative group management component 600 is configured to manage (i.e., add, modify and delete) administrative groups 50. FIG. 6 shows a user interface for an administrative group management component 600, according to one embodiment. The administrative group management component 600 is configured to link asset groups 40 to administrative groups 50. Further, the administrative group management component 600 can display to a user how one or more asset groups 40 is associated with each administrative group 50. In addition, the administrative group management component 600 allows a user to change various permissions of the administration system 1. For example, using the administrative management component a user can modify access permissions, monitor layout ID permissions, client/computing resources and permissions that will allow other users to manage (i.e., view, create, modify and delete) asset groups 40.

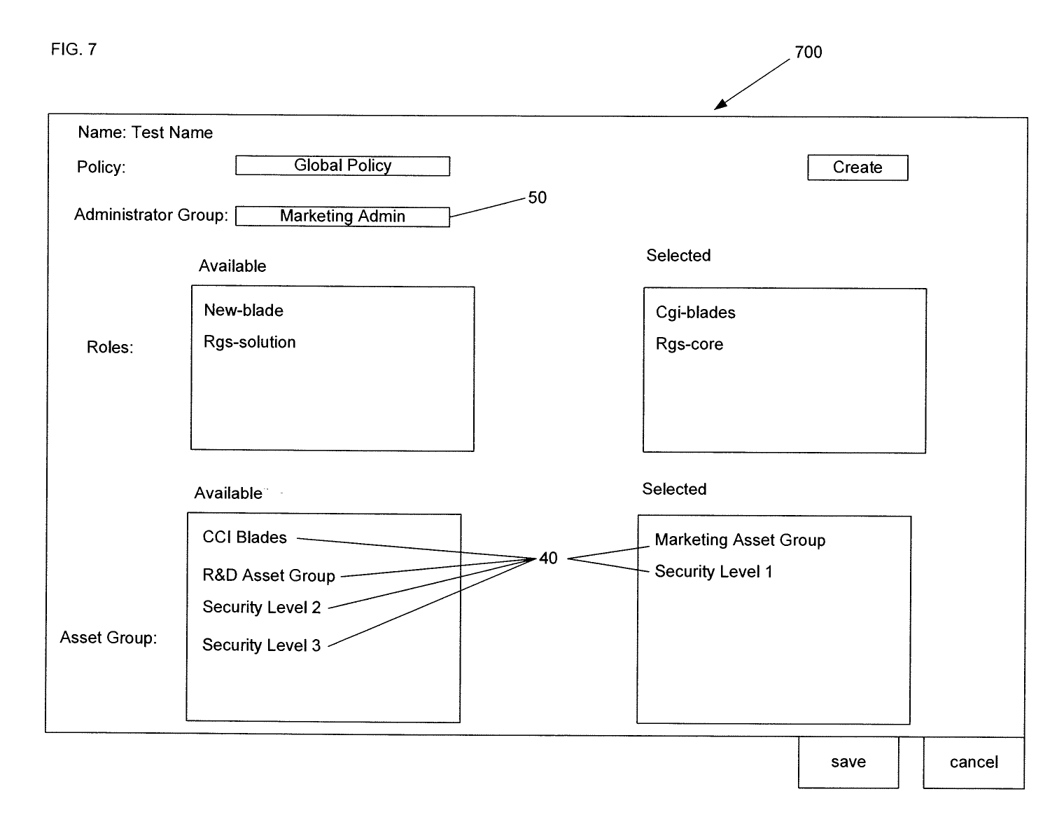

The administrative group assignment component 700 is configured to assign assets to administrative groups 50. FIG. 7 shows a user interface for an administrative group assignment component 700, according to one embodiment. Here, the asset is a user. FIG. 7 shows a user “Test Name” is being added to a Marketing Admin Administrative Group 50. The administrative group assignment component 700 also displays the asset groups 40 that are assigned to the administrative group 50.

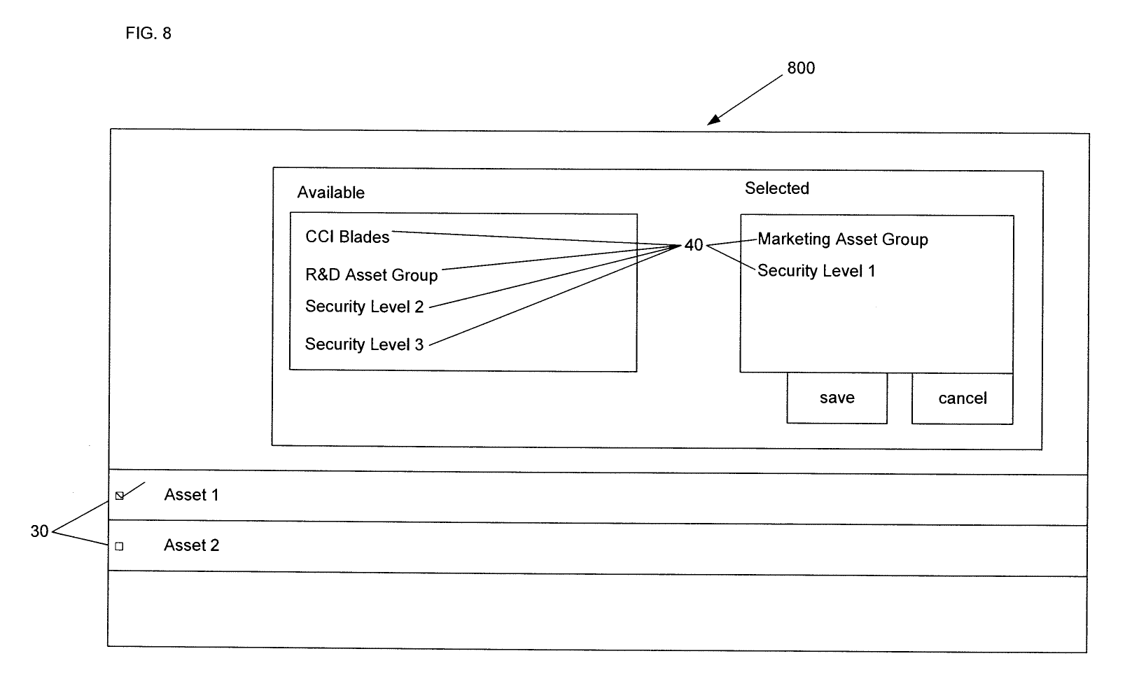

The asset group assignment component 800 is configured to assign assets 30 to asset groups 40. As shown in FIG. 8, the asset 30 (Asset 1) is being assigned to the two selected asset groups 40 (“Market asset group” and “Security level 1”).

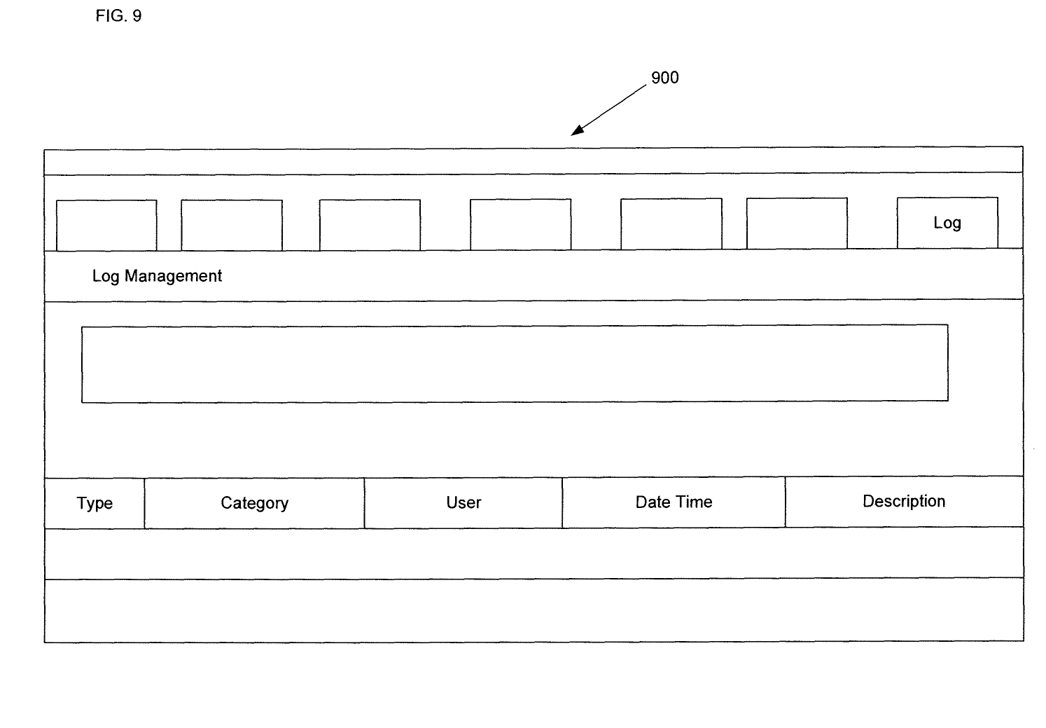

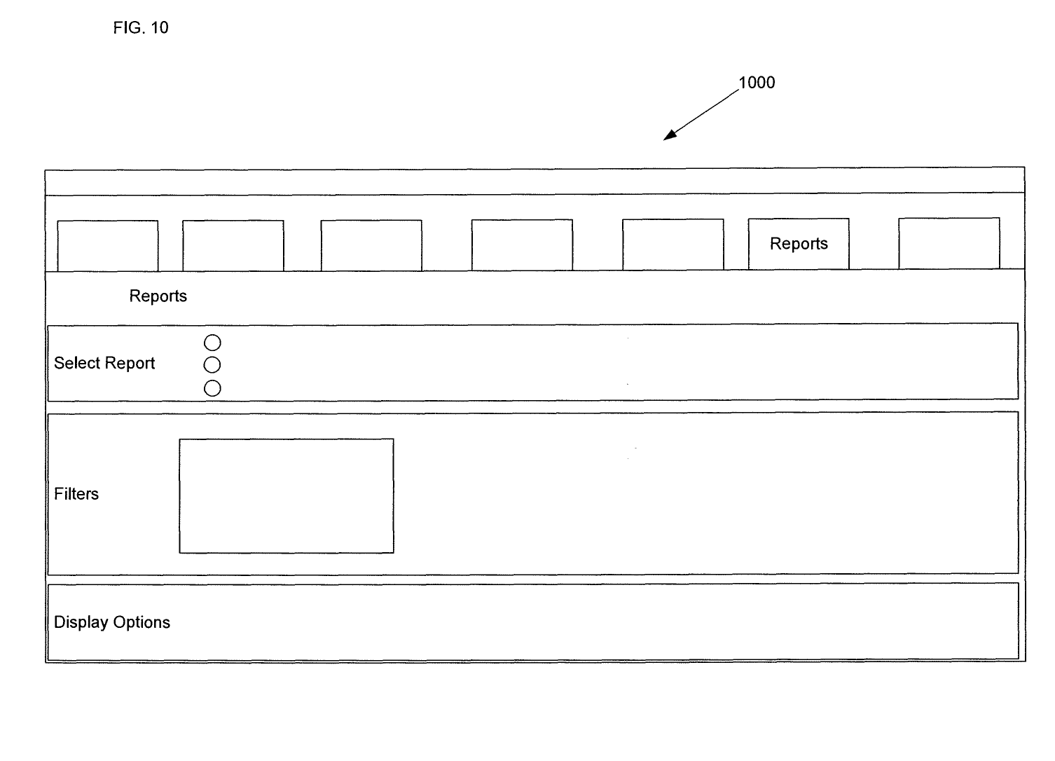

A log component 900 is configured to provide logs to a user of the administration system 1. FIG. 9 shows an exemplary user interface for a log component. According to one embodiment, a user will not be able to access logs associated with asset groups 40 that are not controlled by the administrative group 50 to which the user belongs. A reporting component 1000 is configured to provide reports to a user of the administration system 1. FIG. 10 show an exemplary interface for a reporting component. According to one embodiment, a user will not be able to access reports associated with asset groups 40 that are not controlled by the administrative group 50 to which the user belongs. According to another embodiment, logs and reports are filtered by asset groups and the access permissions (the viewing of web pages) is determined by the properties of the asset group.

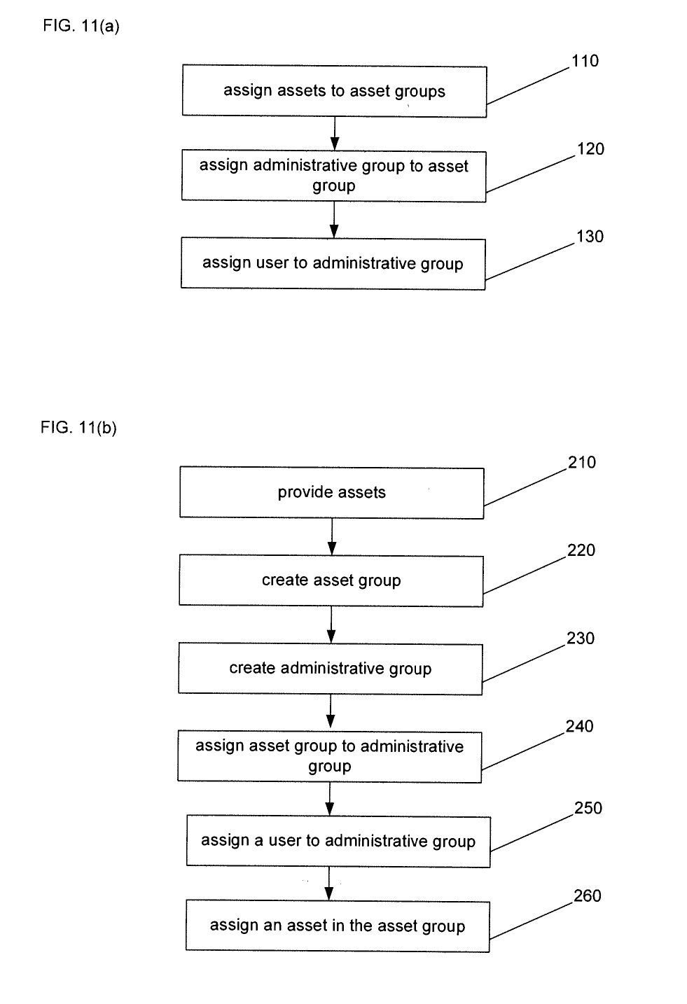

A method for administering assets in a hierarchical manner will now be described in reference to FIGS. 11(a) and 11(b). FIG. 11(a) is a flowchart for administering assets 30 given pre-existing asset groups 40 and administrative groups 50, according to one embodiment. A system administrator 60 can assign assets 30 to one or more asset groups 40 (Step 110). In turn, asset groups 40 can be assigned to one or more administrative groups 50 (Step 120). The system administrator 60 may then assign a user to the administrative group 50 (Step 130). The assigned user has the capability to manage each asset 30 associated with the asset group 40 that is assigned to the administrative group to which the user belongs.

FIG. 11(b) is a flowchart for administering assets 30 according to another embodiment. A plurality of assets 30 are provided (Step 210). The system administrator 60 creates asset groups (Step 220) and administrative groups (Step 230). An asset group 40 may be assigned to one or more administrative group 50 (Step 240). The system administrator 60 may then assign a user to the administrative group 50 (Step 250). An asset 30 may then be assigned to one or more asset groups 40 (Step 260). The assigned user has the capability to manage each asset 30 associated with the asset group 40 that is assigned to the administrative group to which the user belongs.

The above-described embodiments has several advantages. The administration system 1 has the ability to segment the management of remote assets (e.g., computing resources) to a hierarchical grouping of administrators. The administrators are able to fully manage the resources that have been assigned to them. Further, the embodiment may be configured such that the administrators are unable to view or manage any of the assets that have not been assigned to that particular administrator. This protects sensitive assets from unauthorized viewing and management.

The foregoing description has been presented for purposes of illustration and description. It is not intended to be exhaustive or to limit the disclosure to the precise form disclosed, and modifications and variations are possible in light of the above teaching or may be acquired from practice of the invention. The above-mentioned embodiments were chosen and described in order to explain the principles of the disclosure and as a practical application to enable one skilled in the art to utilize the disclosure in various embodiments and with various modification are suited to the particular use contemplated. It is intended that the scope of the invention be defined by the claims appended hereto and their equivalents.

1. A method for administering assets, comprising:
assigning an asset to at least one asset group; and
assigning an administrative group to the asset group, wherein the administrative group is configured to control the asset in the asset group.

2. The method as claimed in claim 1, wherein the assets are selected from a group comprising organizational units, security groups, users, computing resources, monitor layout identifications, roles, policies, logs, reports, or access permissions.

3. The method as claimed in claim 1, wherein assigning the asset to the asset group, comprises tagging the asset with an asset group name associated with the asset group.

4. The method as claimed in claim 1, wherein the administrative group can view an asset in an asset group that the administrative group is not assigned to.

5. The method as claimed in claim 1, further comprising:
assigning a user to the administrative group, wherein the user is configured to manage the asset.

6. The method as claimed in claim 1, further comprising setting a policy governing a use of the asset based upon an identity of the administrative group that is assigned to the asset group.

7. The method as claimed in claim 1, further comprising assigning a set of users to the asset group wherein management of the set of users is restricted to the administrative group that is assigned to the asset group.

8. The method as claimed in claim 1, further comprising setting attributes of the administrative groups.

9. The method as claimed in claim 1, further comprising assigning the asset directly to the administrative group.

10. (canceled)

11. A method for administering assets, comprising:
providing at least one asset;
creating at least one asset group;
creating at least one administrative group;
assigning the asset group to the administrative group;
assigning a user to the administrative group; and
assigning an asset in the asset group; wherein the user is configured to manage the asset.

12. (canceled)

13. (canceled)

14. A system for administering a set of assets, comprising:
a storage device; and
a processor programmed to:
assigning an asset to at least one asset group; and
assigning an administrative group to the asset group, wherein the administrative group is configured to control the asset in the asset group.

15. (canceled)
